(19) United States
(12) Patent Application Publication
(10) Pub. No.: US 2025/0120444 A1
(43) Pub. Date: Apr. 17, 2025

(54) HEATING ASSEMBLY FOR AEROSOL-GENERATING DEVICE

(71) Applicant: Philip Morris Products S.A., Neuchatel (CH)

(72) Inventor: Liu LIU, Huizhou (CN)

(73) Assignee: Philip Morris Products S.A., Neuchatel (CH)

(21) Appl. No.: 18/701,956

(22) PCT Filed: Oct. 25, 2021
(86) PCT No.: PCT/CN2021/126085

§ 371 Date: Apr. 17, 2024

(51) Int. Cl. A24F 40/46; A24F 40/51; A24F 40/70; H05B 3/06

(52) U.S. Cl. CPC A24F 40/46; A24F 40/51; A24F 40/70; H05B 3/06; H05B 2203/016; H05B 2203/017

(57) ABSTRACT

A heating assembly for an aerosol-generating device is provided, the heating assembly including: a heater casing; a heating element including at least two heater contacts; a connector frame; and electric circuitry, the connector frame including at least two connector contacts and being arranged on the heater casing, the at least two connector contacts being electrically connected with the at least two heater contacts and with the electric circuitry, the at least two connector contacts being arranged to directly contact the electric circuitry, and the at least two connector contacts being flat. An aerosol-generating device including the heating assembly is also provided. A method for manufacturing the heating assembly for an aerosol-generating device is also provided.

The present invention relates to a heating assembly for an aerosol-generating device. The invention further relates to an aerosol-generating device and a method for manufacturing a heating assembly.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating assembly may be arranged in or around the heating chamber for heating the aerosol-forming substrate once the aerosol-generating article is inserted into the heating chamber of the aerosol-generating device.

It would be desirable to have a heating assembly for an aerosol-generating device with improved reliability. It would be desirable to have a heating assembly for an aerosol-generating device with improved manufacturing quality. It would be desirable to have a heating assembly for an aerosol-generating device with improved robustness during manufacturing. It would be desirable to have a heating assembly for an aerosol-generating device in which manufacturing is made easier.

According to an embodiment of the invention there is provided a heating assembly for an aerosol-generating device, the heating assembly may comprise one or more of: a heater casing, a heating element, a connector frame and electric circuitry. The heating element may comprise at least two heater contacts. The connector frame may be arranged on the heater casing. The connector frame may comprise at least two connector contacts. The two connector contacts may be electrically connected with the two heater contacts. The two connector contacts may be electrically connected with the electric circuitry.

According to an embodiment of the invention there is provided a heating assembly for an aerosol-generating device, the heating assembly comprising a heater casing, a heating element, a connector frame and electric circuitry. The heating element comprises at least two heater contacts. The connector frame is arranged on the heater casing. The connector frame comprises at least two connector contacts. The two connector contacts are electrically connected with the two heater contacts. The two connector contacts are electrically connected with the electric circuitry.

Manufacturing of the heating assembly is easier due to the provision of the connector frame. Since the connector frame is used to electrically connect the heating element with the electric circuitry, no electrical wiring is needed between the connector frame and the electric circuitry. Hence during manufacture, the connector frame can be easily manually or automatically be connected with the electric circuitry without the need of providing any electric wiring and without the need of providing any soldering.

The heater casing can be configured as a support frame. The further components of the heating assembly can be mounted on the heater casing. The support frame may be formed from any suitable electrically insulating material. Preferably, the support frame is formed from a material that is suitable for moulding over other components of the heating assembly. The support frame may be formed from a polymer material. In particular, the support frame may be formed from a mouldable polymer. Preferably, the support frame is formed from a material that is suitable for use in a moulding process, such as injection moulding. Particularly suitable polymer materials include thermoplastics materials and thermosetting polymers. Suitable polymer materials include: polyphthalamide (PPA), polycarbonate (PC), a blend of polycarbonate and acrylonitrile butadiene styrene (PC-ABS), polyphenylsulfone (PPSU), Polyetheretherketone (PEEK), polypropylene (PP), polyethylene (PE), polyimide (PI), thermoplastic polyimide (TPI), polyamidimide (PAI), and polyetherimide (PEI). The polymer material may be a composite. The composite polymer material may comprise other martials, such as fibrous filler materials, including one or more of carbon fibres and glass fibres. Preferably, the material is light and non-brittle.

Components of the heating assembly such as the connector frame may be at least partially embedded in the support frame. As used herein, the term “embedded” refers to a component that is surrounded by, and secured within another component. In other words, at least a portion of the connector frame may be surrounded by, and secured within the support frame.

Components of the heating assembly such as the connector frame may be at least partially embedded in the support frame in any suitable manner. The support frame may be formed by a moulding process, such as injection moulding. Preferably, at least a portion of the components of the heating assembly such as the connector frame may be overmoulded by electrically insulating material which forms the support frame. In some preferred embodiments, the support frame is formed by overmoulding the electrically insulating material over the base frame and the electrical connector to at least partially embed the base frame and the electrical connector in the support frame.

The connector frame may be rigid. The connector frame may be mounted or attached to the heater casing. Preferably, however, the connector frame is integrally formed with the heater casing. The connector frame may be made from the same material as the heater casing. The connector contacts may be mounted on the connector frame.

The heater contacts of the heating element may be electrically connected with the connector contacts via at least two contact wires. The at least two contact wires may be arranged within the heater casing. The two contact wires may electrically connect the heater contacts. The other ends of the contact wires may electrically connect the connector contacts.

Alternatively, the heater contacts of the heating element may be electrically connected with the connector contacts via rigid contacts. The rigid contacts may electrically contact the heater contacts. The other ends of the rigid contacts may electrically contact the connector contacts. Providing rigid contacts may have the advantage that no manual attachment of the contacts is necessary during manufacture such as performed by manual soldering.

The connector contacts may be rigid. Providing rigid connector contacts preferably has the advantage that the connection between the connector contacts and the electric circuitry can be easily established. Particularly, during manufacture, the electric connection between the connector frame and the electric circuitry may be established by pushing the rigid contacts of the connector frame into contact with the electric circuitry. No further additional steps may be necessary. Particularly, no manual connection such as soldiering of contacts may be necessary.

The heater contacts may be rigid. The heater contacts may be in electric contact with the heating element. Providing rigid heater contacts may be advantageous during manufacturing since no manual soldering or similar steps may be necessary for connecting the rigid heater contacts with the connector contacts. This embodiment is particularly advantageous if the connection between the heater contacts and the connector contacts is made by rigid contacts. In this case, the whole connection between the heating element and the connector frame is made by rigid contacts.

The term ‘rigid’ denotes a physical property of a contact. Such a contact cannot be bent or deformed during normal manufacturing. In contrast, a contact wire is not rigid in the context of this application, since a wire can be bent easily.

The electric circuitry may comprise a printed circuit board. The electric circuitry is a printed circuit board.

The connector contacts may be elongate. Providing elongate connector contacts may be advantageous for contacting the connector contact with the electric circuitry. The electric circuitry may be arranged at a distance from the rest of the elements of the heating assembly. In this case, the elongate connector contacts may bridge the distance between the further elements of the heating assembly and the electric circuitry. This embodiment is particularly advantageous if the connector contacts are also rigid. Providing rigid and elongate connector contacts makes the electrical connection between the connector contacts and the electric circuitry easy during manufacturing and reliable.

The ‘distance’ between the elements of the heating assembly and the electric circuitry may refer to the closest physical distance between the elements of the heating assembly and the electric circuitry. Preferably, however, the ‘distance’ between the elements of the heating assembly and the electric circuitry refers to the distance between the connector frame and the electric circuitry. This distance is preferably bridged by the connector contacts.

The connector contacts may be arranged to directly contact the electric circuitry. In other words, no additional components may be provided between the connector contacts and the electric circuitry. The connector contacts are in this case shaped such that the connector contacts reach the electric circuitry during manufacture and the electrical connection is provided by the connector contacts. This embodiment is particularly advantageous if the connector contacts are one or more of rigid and elongate.

The connector contacts may be flat. Providing flat connector contacts may increase the mechanical stability of the connector contacts. Similarly, the heater contacts may be flat to increase the mechanical stability of the heater contacts.

The heating assembly may further comprise an inner electrically conductive structure. The inner electrically conductive structure may connect the heater contacts to the connector contacts. The inner electrically conductive structure may be arranged within the heater casing.

The heating assembly may further comprise a temperature sensor. The temperature sensor may comprise at least two sensor contacts. The connector frame may comprise at least two additional connector contacts, which are electrically connected with the sensor contacts.

In this embodiment, the connector frame comprises four separate contacts. Two of these contacts may be configured for electrically contacting the heating element. The other two contacts may be configured for electrically contacting the temperature sensor. On the other ends of these four separate contacts, these contacts may be electrically connected with the electric circuitry. In this way, the output of the temperature sensor may be transmitted to the electric circuitry. Further, the electrical circuitry may control the supply of electrical energy to the heating element via the respective contacts contacting the heating element.

The two additional connector contacts may be configured to directly contact the electric circuitry. In other words, the two additional connector contacts electrically contacting the temperature sensor with the electric circuitry may be configured similar to the two connector contacts described herein for electrically contacting the heating element with the electric circuitry. This particularly means that these two additional connector contacts may be one or more of flat, rigid and elongate with the same advantages described herein with respect to the connector contacts for contacting the heating element with the electric circuitry.

The invention further relates to an aerosol-generating device comprising the heating assembly as described herein.

The aerosol-generating device may comprise a cavity for receiving an aerosol-generating article. The heating assembly may be arranged at least partly surrounding the cavity.

A sidewall of the cavity may be formed of the tube described herein, preferably a stainless-steel tube. The heating assembly may be mounted on the stainless-steel tube or the tube may be part of the heating assembly and mounted within the housing or an inner frame of the aerosol-generating device.

The invention further relates to a method for manufacturing a heating assembly for an aerosol-generating device, the method may comprise one or more of the following steps:
providing a heater casing,
providing a heating element, the heating element comprising at least two heater contacts,
providing a connector frame, wherein the connector frame is integrally formed with the heater casing, wherein the connector frame comprises at least two connector contacts, and
providing electric circuitry,
electrically connecting the two connector contacts with the two heater contacts, and
electrically connecting the two connector contacts with the electric circuitry.

The invention further relates to a method for manufacturing a heating assembly for an aerosol-generating device, the method comprising the steps of:
providing a heater casing,
providing a heating element, the heating element comprising at least two heater contacts,
providing a connector frame, wherein the connector frame is integrally formed with the heater casing, wherein the connector frame comprises at least two connector contacts, and
providing electric circuitry,
electrically connecting the two connector contacts with the two heater contacts, and
electrically connecting the two connector contacts with the electric circuitry.

The heating assembly may comprise a first substrate layer, the first substrate layer being an electrically isolating substrate layer. The heating element may be arranged on the first substrate layer. The heating assembly may further comprise a second substrate layer, the second substrate layer may be an electrically isolating substrate layer. The second substrate layer may be arranged covering the heating element and the first substrate layer. The temperature sensor may be arranged on the second substrate layer. The heating assembly may further comprise a third substrate layer, the third substrate layer may be an electrically isolating substrate layer. The third substrate layer may be arranged at least partly covering the temperature sensor and covering the second substrate layer.

The term ‘covering’ or ‘cover’ may mean that a first layer has the substantial same surface size as a second layer so that the first layer can be placed on the second layer in a way that the surface area of the second layer facing the first layer is substantially overlapped by the first layer. In case a first layer is arranged covering a second layer, the surface size of the first layer may be at least 90% of the surface area of the second layer, preferably the surface size of the first layer may be at least 80% of the surface area of the second layer, more preferably the surface size of the first layer may be at least 70% of the surface area of the second layer, most preferably the surface size of the first layer may be at least 60% of the surface area of the second layer

In the final heating assembly, the heating element and the temperature sensor are preferably arranged on opposite surfaces of the second substrate layer. Hence, the heating element is electrically isolated from the temperature sensor via the second substrate layer.

The heating element is protected by the first substrate layer and by the second substrate layer.

The temperature sensor is protected by the second substrate layer and by the third substrate layer.

The heating element may be a resistive heater. The heating element may comprise a heating track. The heating element may be a heating track. The heating tracks may be configured to generate heat. The heating tracks may be electrically resistive heating tracks. The heating elements may comprise electrical contacts for electrically contacting the heating tracks. The electrical contacts may be attached to the heating tracks by any known means, exemplarily by soldering or welding. A first electrical contact may be attached to a first end of the heating tracks and a second electrical contact may be attached to a second end of the heating tracks. The first end of the heating tracks may be a proximal end of the heating tracks and the second end of the heating tracks may be a distal end of the heating tracks or vice versa.

The heating tracks may be made from stainless-steel. The heating tracks may be made from stainless-steel at about 50 μm thickness. The heating tracks may be preferably made from stainless-steel at about 25 μm thickness. The heating tracks may be made from inconel at about 50.8 μm thickness. The heating tracks may be made from inconel at about 25.4 μm thickness. The heating tracks may be made from copper at about 35 μm thickness. The heating tracks may be made from constantan at about 25 μm thickness. The heating tracks may be made from nickel at about 12 μm thickness. The heating tracks may be made from brass at about 25 μm thickness.

The heating element, preferably the heating tracks, may be printed on the first substrate layer. The heating tracks may be photo-printed on the substrate layer. The heating tracks may be chemically etched on the substrate layer.

The term ‘heating tracks’ encompasses a single heating track. The heating element or the heating tracks may be printed on the first substrate layer.

The heating tracks may be centrally arranged on the first substrate layer. The heating tracks may have a bench shape. The heating tracks may have a curved shape.

The heating assembly may be rolled into a tube. The heating tracks may be flat before the substrate layer is rolled into the tubular shape. The heating tracks or the heating element may be flexible. The heating tracks or the heating element may conform to the tubular shape of the substrate layer when the substrate layer is rolled into the tubular shape.

The third substrate layer may comprise at least two openings. The two openings are provided for enabling the sensor contacts to be contacted through the third substrate layer.

The two openings may be aligned such that the sensor contacts are not covered by the third substrate layer. The two openings may be arranged adjacent to opposite ends of the third substrate layer. The two openings may correspond to the placement of electrical contacts on the temperature sensor.

In addition to the two openings, a further opening may be provided in the third substrate layer. The third opening may be arranged centrally in the third substrate layer. This third opening may increase the mechanical strength of the third substrate layer in this area. Particularly, the opening in the middle of the third substrate layer may strengthen the fixation of the contacts contacting the sensor contacts, since the contacts come into contact with the underlying adhesive layer of the second substrate layer in this area.

The sensor contacts may be attached to the temperature sensor by any known means, exemplarily by soldering or welding. A first electrical contact may be attached to a first end of the temperature sensor and a second electrical contact may be attached to a second end of the temperature sensor. The first end of the temperature sensor may be a proximal end of the temperature sensor and the second end of the temperature sensor may be a distal end of the temperature sensor or vice versa.

The temperature sensor may comprise temperature sensor tracks.

The heating assembly may comprise a tube, preferably a metal tube, around which the substrate layer may be wrapped or rolled. The metal tube is preferable a stainless-steel tube. Alternatively, the tube may be a ceramic tube. The tube may define the tubular shape of the heating assembly. The outer diameter of the tube may correspond to the inner diameter of the first substrate layer after rolling of the substrate layer.

The heating assembly may further comprise a heating chamber conformed by the tubular shape of the heating assembly. The substrate layers together with the heating element and the temperature sensor may be rolled to conform the tube forming the heating chamber. In this configuration, the first substrate layer may form the inner layer facing the tube and the third substrate layer may be the outer layer. The first substrate layer may be adjacent the metal tube forming the innermost layer of the heating assembly.

The tube may be made from stainless-steel. The tube may have a length of between 10 mm and 35 mm, preferably between 12 mm and 30 mm, preferably between 13 mm and 22 mm. The tube may be a hollow tube. The hollow tube may have an internal diameter of between 4 mm and 9 mm, preferably between 5 mm and 6 mm or between 6.8 mm and 7.5 mm, preferably around 5.35 mm or around 7.3 mm. The tube may have a thickness of between 70 μm and 110 μm, preferably between 80 μm and 100 μm, preferably around 90 μm. The tube may have a cylindrical cross-section. The tube may have a circular cross-section.

The length of the first substrate layer may be equal to or less than the circumference of the tube. The first substrate layer may fully wrap around the tube. The first substrate layer may wrap around the tube once such that the surface of the tube is covered by the first substrate layer after the first substrate layer has been wrapped around the tube.

The tube of the heating chamber may have a thickness of between 70 μm and 110 μm, preferably between 80 μm and 100 μm, preferably around 90 μm.

The temperature sensor may be an NTC, a Pt100 or preferably a Pt1000 temperature sensor. The temperature sensor may be attached to the second substrate layer by means of an adhesive layer. The temperature sensor may be photo-printed onto the second substrate layer. Chemical etching may be utilized for forming one or both of the heating tracks of the heating element and the temperature sensor tracks. Subsequently, the sensor contacts may be welded on the temperature sensor tracks through the openings in the third substrate layer.

The temperature sensor may be positioned on the second substrate layer such that when the heating assembly is rolled up, the temperature sensor may be positioned in an area corresponding to the centre of the first substrate layer. By positioning the temperature sensor in this way, the heating element may be mapping the temperature sensor so that the temperature sensor is positioned adjacent the hottest part of the heating element. The hottest part adjacent the temperature sensor may be the centre of the first substrate layer. The heating element may be arranged at the center of the first substrate layer. The temperature sensor may be arranged directly adjacent the heating element only distanced from the heating element by the thickness of the second substrate layer.

One or more of the following additional layers may be provided:
a first adhesive layer may be provided between the first substrate layer and the heating element,
a second adhesive layer may be provided between the heating element and the second substrate layer,
a third adhesive layer may be provided between the second adhesive layer and the temperature sensor, and
a fourth adhesive layer may be provided between the temperature sensor and the third substrate layer.

The first adhesive layer may facilitate attachment between the first substrate layer and the heating element. The first adhesive layer may further facilitate attachment between the first substrate layer and the second substrate layer in the area of the first substrate layer not covered by the heating element. The second adhesive layer may facilitate attachment between the heating element and the second substrate layer. The third adhesive layer may facilitate attachment between the second substrate layer and the temperature sensor. The third adhesive layer may further facilitate attachment between the second substrate layer and the third substrate layer in the area of the third adhesive layer not covered by the temperature sensor. The fourth adhesive layer may facilitate attachment between the temperature sensor and the third substrate layer.

One or more of the adhesive layers may have a thickness of between 2 μm and 10 μm, preferably between 3 μm and 7 μm, more preferably around 5 μm.

One or more of the adhesive layers may be a silicon-based adhesive layer. The adhesive layer may comprise one or both of PEEK-based adhesives and acrylic adhesives.

One or more of the first substrate layer, the second substrate layer and the third substrate layer may comprise a polyamide or polyimide film. Any of the substrate layers may be made from polyimide or polyamide. The substrate layers may be configured to withstand between 220° C. and 320° C., preferably between 240° C. and 300° C., preferably around 280° C. Any of the substrate layers may be made from Pyralux.

A heat shrink layer may be arranged around the heating assembly.

The heat shrink layer may be arranged around the heating assembly when the heating assembly is rolled into the tubular shape. The heat shrink layer may be configured to shrink when heated. The heat shrink layer may securely hold the heating assembly together. The heat shrink layer may be configured to apply a uniform inwards pressure to the heating assembly. The heat shrink layer may improve the contact between one or both of the tube and the first substrate layer and the first substrate layer and the second substrate layer. The heat shrink layer may hold most or all components of the heating assembly tight together. The heat shrink layer may be employed to replace the glue layers or adhesive layers described herein. Alternatively, the heat shrink layer may be employed in addition to the glue layers or adhesive layers described herein.

The thickness of the heat shrink layer may be between 100 μm and 300 μm, preferably around 180 μm.

The heat shrink layer may be made of PEEK. The heat shrink layer may be made of or comprise one or more of Teflon and PTFE.

One or more of the substrate layers may have a thickness of between 10 μm and 50 μm, preferably between 20 μm and 30 μm, more preferably around 25 μm.

The heating element may, when preferably made of stainless-steel, have a thickness of between 20 μm and 60 μm, preferably between 30 μm and 50 μm, more preferably around 40 μm. The heating tracks may, when preferably made of stainless-steel, have a thickness of between 20 μm and 60 μm, preferably between 30 μm and 50 μm, more preferably around 40 μm.

Surrounding the heat shrink layer, a thermally insulating layer may be provided. The thermal insulating layer is preferably made of aerogel.

As used herein, the terms “upstream” and “downstream”, are used to describe the relative positions of components, or portions of components, of the aerosol generating device in relation to the direction in which airflows through the aerosol generating device during use thereof. Aerosol generating devices according to the invention comprise a proximal end through which, in use, an aerosol exits the device. The proximal end of the aerosol generating device may also be referred to as the mouth end or the downstream end. The mouth end is downstream of the distal end. The distal end of the aerosol generating article may also be referred to as the upstream end. Components, or portions of components, of the aerosol generating device may be described as being upstream or downstream of one another based on their relative positions with respect to the airflow path of the aerosol generating device.

In all of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics.

As described, in any of the aspects of the disclosure, the heating element may comprise an external heating element, where “external” refers to the aerosol-forming substrate. An external heating element may take any suitable form. For example, an external heating element may take the form of one or more flexible heating foils or heating tracks on a dielectric substrate, such as polyimide. The dielectric substrate is the substrate layer. The flexible heating foils or heating tracks can be shaped to conform to the perimeter of the heating chamber. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on the suitable shaped substrate layer. An external heating element may also be formed using a metal having a defined relationship between temperature and resistivity. In such an exemplary device, the metal may be formed as a track between the first substrate layer and the second substrate layer. An external heating element formed in this manner may be used to both heat and monitor the temperature of the external heating element during operation.

The heating element advantageously heats the aerosol-forming substrate by means of conduction. Alternatively, the heat from either an internal or external heating element may be conducted to the substrate by means of a heat conductive element.

During operation, the aerosol-forming substrate may be completely contained within the aerosol-generating device. In that case, a user may puff on a mouthpiece of the aerosol-generating device. Alternatively, during operation a smoking article containing the aerosol-forming substrate may be partially contained within the aerosol-generating device. In that case, the user may puff directly on the smoking article.

The heating element may be configured as an induction heating element. The induction heating element may comprise an induction coil and a susceptor. In general, a susceptor is a material that is capable of generating heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate. When an induction heating element is employed, the induction heating element may be configured as an external heater as described herein. If the induction heating element is configured as an external heating element, the susceptor element is preferably configured as a cylindrical susceptor at least partly surrounding the heating chamber. The heating tracks described herein may be configured as a susceptor. The susceptor may be arranged between the first substrate layer and the second substrate layer. The second substrate layer may be surrounded by the induction coil. The susceptor as well as the induction coil may be part of the heating assembly.

Preferably, the aerosol-generating device comprises a power supply configured to supply power to the one or both of the heating element and the heating assembly. The power supply preferably comprises a power source. Preferably, the power source is a battery, such as a lithium ion battery. As an alternative, the power source may be another form of charge storage device such as a capacitor. The power source may require recharging. For example, the power source may have sufficient capacity to allow for the continuous generation of aerosol for a period of around six minutes or for a period that is a multiple of six minutes. In another example, the power source may have sufficient capacity to allow for a predetermined number of puffs or discrete activations of the heating assembly.

The aerosol-generating device may comprise control electronics. The control electronics may comprise a microcontroller. The microcontroller is preferably a programmable microcontroller. The electric circuitry may comprise further electronic components. The electric circuitry may be configured to regulate a supply of power to the heating assembly. Power may be supplied to the heating assembly continuously following activation of the system or may be supplied intermittently, such as on a puff-by-puff basis. The power may be supplied to the heating assembly in the form of pulses of electrical current.

Similarly, the length of the electrical connections between the heating element and the control electronics may be longer than the distance between the heating element and the control electronics. This may have the beneficial effect of preventing a detrimental effect on the electrical contact between the heating element and the control electronics due to thermal expansion of the contacts during operation of the aerosol-generating device. The electrical connections are preferably configured as electrical wires.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or liquid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. An aerosol-generating article may be disposable.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomiser, such as an electric heater, to heat the aerosol-forming substrate to form an aerosol.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

Features described in relation to one embodiment may equally be applied to other embodiments of the invention.

The invention will be further described, by way of example only, with reference to the accompanying drawings in which:

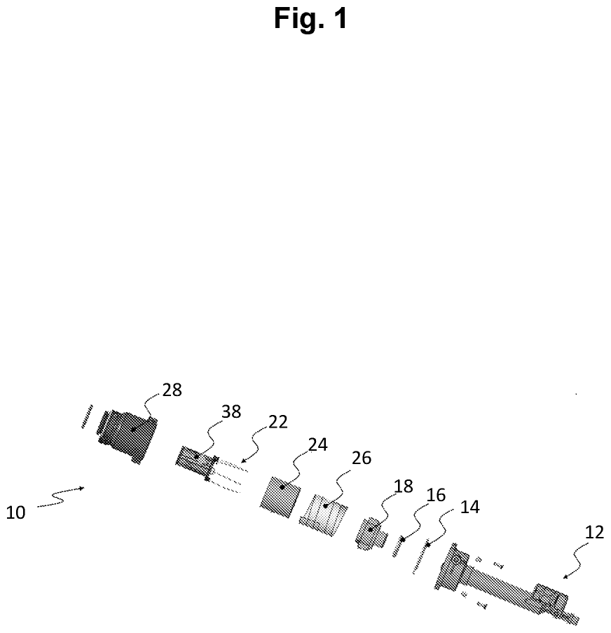

FIG. 1 shows a heating assembly;

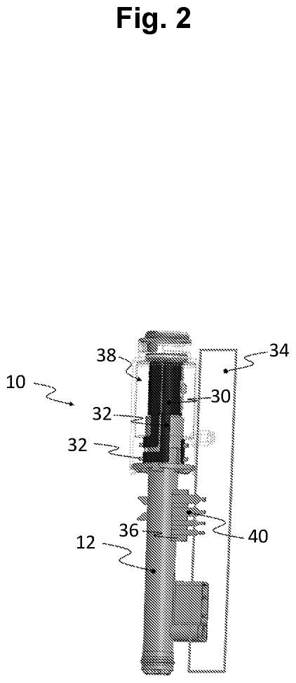

FIG. 2 shows an aerosol-generating device; and

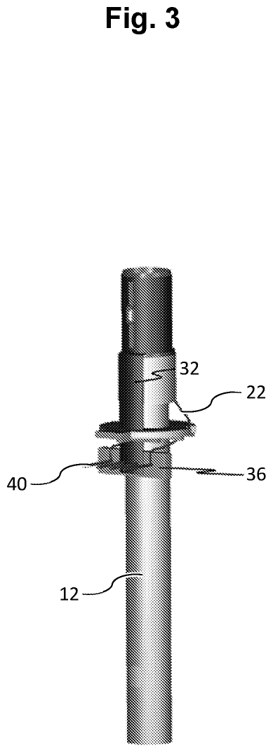

FIG. 3 shows a different perspective of the heating assembly.

FIG. 1 shows a heating assembly 10. The heating assembly 10 comprises a heater casing 12. Next to the heater casing 12, a first sealing ring 14 and a second sealing ring 16 are arranged. The first sealing ring 14 and the second sealing ring 16 are followed by a tube holder 18.

FIG. 1 further shows a heating element 38. For contacting the heating element 38, contact wires 22 are shown in FIG. 1. The heating element 38 is surrounded by aerogel 24 for thermal insulation. Further, an insulating film 26 may be provided surrounding the aerogel 24.

FIG. 1 further shows a top heater casing 28 as part of the heating assembly 10.

FIG. 2 shows an embodiment of the heating assembly 10, in which the heating assembly 10 has a tubular shape so as to form a heating chamber. The heating element 38 comprises heating tracks 30. The layers surrounding the heating tracks 30 are transparent such that the heating tracks 30 and heater contacts 32 can be seen. In contrast to the embodiment shown in FIG. 1, the heating element 38 is contacted by the heater contacts 32 and not via contact wires 22. The heater contacts 32 are rigid in contrast to the non-rigid contact wires 22 shown in FIG. 1.

The heater contacts 32 are configured to run internally through the heater casing 12 towards the connector frame 36. The connector frame 36 comprises connector contacts 40. The connector contacts 40 are rigid, flat and elongate. The heater contacts 32 are arranged to electrically contact the heating element 38 with two of the four connector contacts 40 shown in FIG. 2.

The two connector contacts 40 electrically connected with the heating element 38 via the heater contacts 32 are configured to electrically contact the electric circuitry 34. The electric circuitry 34 is preferably configured as a printed circuit board. Due to the provision of the rigid connector frame 36 and the rigid connector contacts 40, an easy and reliable connection can be established between the heater casing 12 comprising the heating element 38 and the electric circuitry 34.

The further two connector contacts 40 are configured to electrically connect a temperature sensor (not shown) of the heating assembly 10 with the electric circuitry 34. The temperature sensor is preferably arranged surrounding the heating element 38 and is transparent in FIG. 2. In other words, the connector frame 36 having four separate connector contacts 40 facilitate a reliable and easy electrical contacting between the heating element 38 and the temperature sensor on the one side and the electric circuitry 34 on the other side.

FIG. 3 shows an alternative embodiment of the heating assembly 10. All components of the heating assembly 10 are identical to the embodiment shown in FIG. 2 except for the fact that contact wires 22 are provided in addition to rigid heater contacts 32. For example, the contact wires 22 can be arranged to electrically contact the temperature sensor on one end and to electrically contact two of the connector contacts 40 on the other end. In this case, the rigid heater contacts 32 are provided to electrically contact the heating element 38 with the connector contacts 40. If feasible, the contact wires 22 could also be utilized for electrically connecting the heating element 38 with the connector contacts 40 and rigid contacts could be utilized for electrically contacting the temperature sensor with the connector contacts 40. Similar to the FIG. 2 embodiment, the connector contacts 40 are elongate and rigid to electrically contact the heating element 38 at the temperature sensor with the electric circuitry 34.

1.-15. (canceled)

16. A heating assembly for an aerosol-generating device, the heating assembly comprising:
a heater casing;
a heating element comprising at least two heater contacts;
a connector frame; and
electric circuitry,
wherein the connector frame is arranged on the heater casing,
wherein the connector frame comprises at least two connector contacts,
wherein the at least two connector contacts are electrically connected with the at least two heater contacts,
wherein the at least two connector contacts are electrically connected with the electric circuitry,
wherein the at least two connector contacts are arranged to directly contact the electric circuitry, and
wherein the at least two connector contacts are flat.

17. The heating assembly according to claim 16, wherein the at least two heater contacts of the heating element are electrically connected with the at least two connector contacts via at least two contact wires.

18. The heating assembly according to claim 16, wherein the at least two heater contacts of the heating element are electrically connected with the at least two connector contacts via rigid contacts.

19. The heating assembly according to claim 16, wherein the at least two connector contacts are rigid.

20. The heating assembly according to claim 16,
further comprising an inner electrically conductive structure,
wherein the inner electrically conductive structure connects the at least two heater contacts to the at least two connector contacts.

21. The heating assembly according to claim 16, wherein the at least two heater contacts are one or both of flat and rigid.

22. The heating assembly according to claim 16, wherein the electric circuitry comprises a printed circuit board.

23. The heating assembly according to claim 16, wherein the at least two connector contacts are elongate.

24. The heating assembly according to claim 16, further comprising a temperature sensor.

25. The heating assembly according to claim 24,
wherein the temperature sensor comprises at least two sensor contacts, and
wherein the connector frame comprises at least two additional connector contacts, which are electrically connected with the at least two sensor contacts.

26. The heating assembly according to claim 25, wherein the at least two additional connector contacts are configured to directly contact the electric circuitry.

27. An aerosol-generating device comprising the heating assembly according to claim 16.

28. A method for manufacturing a heating assembly for an aerosol-generating device, the method comprising the steps of:
providing a heater casing;
providing a heating element comprising at least two heater contacts;
providing a connector frame, wherein the connector frame is integrally formed with the heater casing, wherein the connector frame comprises at least two connector contacts;
providing electric circuitry;
electrically connecting the at least two connector contacts with the at least two heater contacts; and
electrically connecting the at least two connector contacts with the electric circuitry,
wherein the at least two connector contacts are arranged to directly contact the electric circuitry, and
wherein the at least two connector contacts are flat.
